(19) United States
(12) Patent Application Publication
(10) Pub. No.: US 2003/0162529 A1
(43) Pub. Date: Aug. 28, 2003

(54) Method and interactive exchange between a subscriber identification module co-operating with a terminal in a radiotelephone, and a local device

(76) Inventor: Gerard Noblins, Courbevoie (FR)

Correspondence Address: Robert M Angus, Westman Champlin & Kelly, International Centre Suite 1600, 900 Second Avenue South, Minneapolis, MN, 55402-3319, US

(21) Appl. No.: 10/276,957

(22) PCT Filed: May 23, 2001
(86) PCT No.: PCT/FR01/01617

(30) Foreign Application Priority Data
May 26, 2000 (FR) 00/06866
Aug. 1, 2000 (FR) 00/10173

(51) Int. Cl. H04M 1/66

(52) U.S. Cl. 455/411; 455/558

(57) ABSTRACT

The invention concerns a method for interactive exchange between a subscriber identification module, co-operating with a terminal in a radiotelephone, and at least a local device. The invention is characterised in that it provides a step which consists in using a first communication channel between the local device and the subscriber identification module. Said first communication channel carries at least a message enabling the subscriber identification module to receive and/or request information from the local device and/or vice-versa.

The field of the invention is that of radio-communications system, namely, but not exclusively, using the GSM (“global system for modular communications”), DCS 1800 (“digital cellular system 1800 MHz”), PCS 1900 (“personal communication system”), DECT (“digital European cordless telecommunications) or even UMTS (“universal mobile telecommunications system”).

Classically, in a radio communications system each subscriber is provided with a radiotelephone making it possible for him to access telecommunications services while mobile within a network of geographic cells. The radiotelephone (or MS for “mobile station” according to GSM terminology) comprises a terminal (or ME for “mobile equipment” according to GSM terminology) cooperating with a subscriber identification module (or SIM card for “subscriber identity module” according to GSM terminology or even DAM for “DECT authentication module” according to DECT terminology).

More precisely, the invention relates to a method for interactive exchange between a subscriber identification module and at least one local device intended to enable the subscriber identification module to receive and/or to request information from the local device and/or vice-versa.

“Local device” is understood to mean complementary equipment (a micro-computer, for example) that is not part of the radio-communications system. It is important to note that it does not interact with the subscriber identification module via the radio-communications network. In other respects, the local device occupies a defined geographical position as a function of the role that it plays in the context of the interaction that it establishes with the subscriber identification module.

The present invention presents many applications such as, for example:

information exchange between two applications situated on the one hand on or upstream of a subscriber identification module and on the other hand one or downstream of the local device;

detection by the local device of the presence of the subscriber identification module in a fixed, predetermined location;

control by the local device of access by the user of the radiotelephone (in which the subscriber identification module is incorporated) at a given place and or service;

authentication and/or identification by the local device of the user of the radiotelephone in which the subscriber identification module is incorporated;

management by the local device of electronic payment transactions effected by the user of the radiotelephone in which the subscriber identification module is incorporated;

loading of information by the local device in a list or otherwise from the terminal and/or the subscriber information module;

downloading of data files or applications by the local device;

loading of data or applications by the local device from local computer equipment (connected to the local device) to the subscriber identification module and/or the terminal and/or a system upstream of the terminal/subscriber identification module pair;

etc.

Generally, the present invention can be applied in all cases where, in order to use one or a plurality of functionalities, one wishes that a first application, located on upstream of the subscriber identification module, communicates with a second application, located on or downstream of the local device. The upstream of the subscriber identification module is defined as being either the terminal or a radio communications network to which the terminal accesses, or a system connected to the radio-communications network. The downstream of the local device is defined as any equipment connected directly or indirectly to the local device.

By way of information, two well-known techniques for interaction involving a radiotelephone will now be presented. In the two cases, the radiotelephone is the type comprising a terminal co-operating with a subscriber identification module.

According to the first known technique, a local device pilots the terminal incorporated in the radiotelephone. In this context, the local device is called third-party equipment (or TE for “terminal equipment” according to GSM terminology). It is a microcomputer, for example. The control, based on a set of commands and indication in AT format (or “ATtention command”), allows the third-party equipment to require the terminal to execute certain predefined actions. A detailed description of these AT commands can be found in the ETSI “GSM 07.07 AT command set for GSM mobile equipment” standard.

This first well-known method does not propose in any way whatsoever using the third party equipment (local device) with the subscriber identification module incorporated in the radiotelephone. In fact, the local device interacts solely with the terminal.

According to the second well-known method, the subscriber identification module controls the terminal. No local device is involved in this interaction. The control is based on a set of “SIM application toolkit” commands”. A detailed description of these commands can be found in the ETSI “GSM 11.14 SIM Application Toolkit” standard. This second well-known method provides interaction via the controlled terminal and the radio-communications network, between the subscriber identification module and a server of the radio communications system (for a banking application implemented in the form of exchange of short messages, for example).

This second well-known technique does not provide for tying-in the subscriber identification module with a local device.

The object of the invention, therefore, is to eliminate these various drawbacks of the prior art.

More precisely, one of the objects of the present invention is to provide a method of interaction between a subscriber identification module and (at least) one local device.

A further object of the invention is to provide such a method that allows increasing the number and diversity of the applications that can be executed by the subscriber identification modules.

A further object of the invention is to provide such a method that, in at least one of its embodiments, does not require any modification of the terminal with which the subscriber identification module co-operates.

A complementary object of the invention is to provide such a method that is simple to use, less costly and secured.

These various objects, as well as others that will become apparent in the following, are achieved by the invention with the aid of a method for interaction between on the one hand a subscriber identification module cooperating with a terminal within a radio-telephone and on the other hand at least one local device. According to the invention the method comprises one step using a first communications channel between the local device and the subscriber identification module. This first communications channel carries at least one message enabling the subscriber identification module to receive and/or request information from the local device and/or vice-versa.

The general principle of the invention thus consists of bringing about an interaction between two entities; that is, a subscriber identification module and at least one local device, that prior to this did not have the possibility of communicating with each other.

This novel type of interaction makes possible increasing the number and variety of applications that can be carried out by the subscriber identification modules. In other words, the operators of radio-communications networks (of the providers of services with which said operators have made agreements) can offer new services to their customers to whom they provide the subscriber identification modules.

This novel type of interaction can also replace interaction between the terminal and third-party equipment. In other words, for certain services, the subscriber identification module can take the place of the terminal. This enables the operators of radio-communications networks to include in their service offerings and functionalities that they offer to their customers' services and or functionalities that were up to now the sole purview of the terminal manufacturers.

Advantageously, the first communications channel implements a unilateral exchange of messages between two applications situated on the one hand on or upstream of the subscriber identification module and on the other hand on or downstream of the local device. The upstream of the subscriber identification module is defined as either the terminal or a radio communications network to which the terminal has access or a system connected to the radio communications network. The downstream of the local device is defined as any equipment connected directly or indirectly to the local device.

In an advantageous application of the invention, the first communications channel is used to detect the presence of the radiotelephone within a predefined fixed place, wherein:

the geographic position is defined by the geographic position of the local device;

the extent is defined by the range of a contact or quasi-contact between the local device and the radiotelephone via which the first communications channel is implemented;

It is clear that the present invention has many other applications (see the non-exhaustive list below).

In a first particular embodiment of the invention the first communications channel is used for a nonphysical contact, so called quasi-contact, between the subscriber identification module and said at least one local device. “Quasi-contact” (between the subscriber identification module and the local device) is understood to mean all types of proximity connection without physical contact. Several preferred methods of implementing this quasi-contact are described in detail in the following description (contactless, “etiquette”, infrared, electromagnetic connection communications, base station emulation, local wireless network communications).

Thus, in this first embodiment, the subscriber identification module communicates directly with the local device. No modification of the terminal, with which the subscriber identification module is cooperating, is necessary.

In a second particular embodiment of the invention, the first communications channel is implemented by:

a first physical contact between the subscriber identification module and the terminal, and

a second physical contact between the terminal and said at least one local device.

Thus, in contrast with the first embodiment, the communication between the subscriber identification module and the local device is not made directly but via the terminal.

“Physical contact” (between the subscriber identification module and the terminal or between the terminal and said at least one local device) is understood to mean a physical contact of the electrical, electronic, mechanical type (or a combination of several of these types).

In a third particular embodiment of the invention the first communications channel is implemented by:

a first physical contact between the subscriber identification module and the terminal, and

a second non-physical contact, a so-called quasi-contact, between the terminal and said at least one local device.

As in the second embodiment, the communication between the subscriber identification module and the local device is effected via the terminal.

The invention relates also to a radiotelephone of the type comprising a terminal and a subscriber identification module. According to the invention, said radiotelephone comprises the means of implementing one communications channel between the subscriber identification module and a local device, the communications channel carrying at least one message enabling the subscriber identification module to receive and/or to request information from the local device and/or vice-versa.

The invention relates also to a subscriber identification module of the type intended to cooperate with a terminal within a radiotelephone. According to the invention, said subscriber identification module comprises means of implementing a communications channel between the subscriber identification module and a local device, the communications channel carrying at least one message enabling the subscriber identification module to receive and/or to request information from the local device and/or vice-versa.

The invention relates also to a local device of the type intended to communicate with a subscriber identification module, the subscriber identification module co-operating with a terminal within the radiotelephone. According to the invention, said local device comprises means for implementing a communications channel between the local device and the subscriber identification module, the communications channel carrying at least one message enabling the subscriber identification module to receive and/or to request information from the local device and/or vice-versa.

Other characteristics and advantages of the invention will become apparent on reading the following description of a preferred embodiment of the invention, given as a non-limiting example, together with the annexed drawings, wherein:

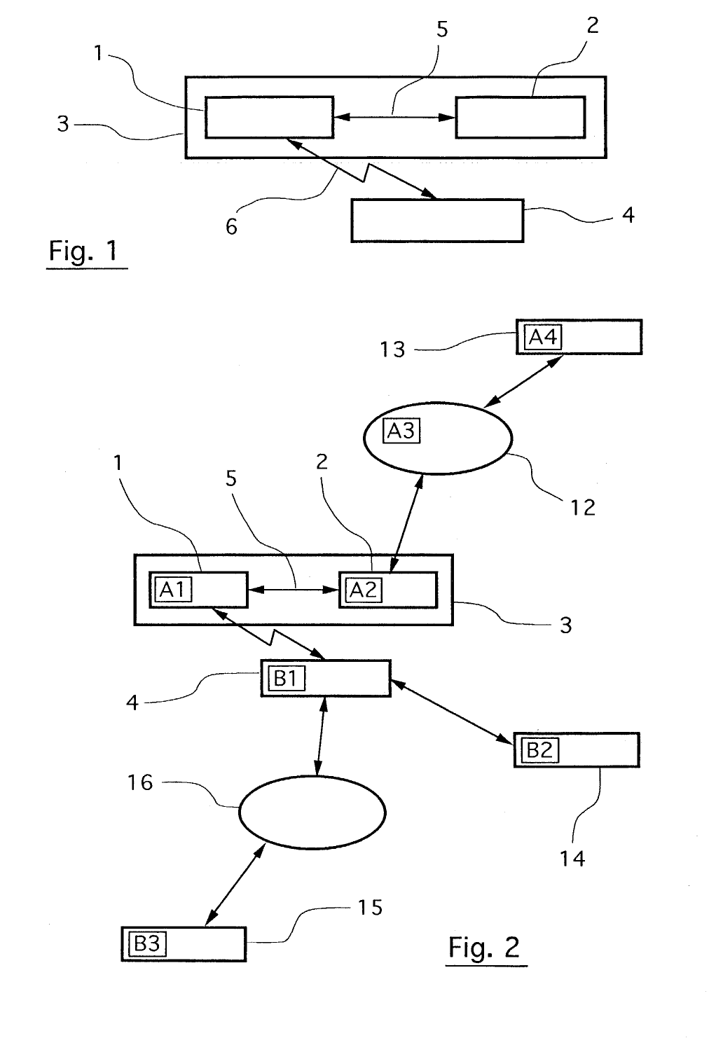

FIG. 1 represents a first particular embodiment of the method according to the invention for interactive exchange between a subscriber identification module and a local device;

FIG. 2 represents different alternative embodiments of an exchange of messages between two applications, in the context of the interactive structure represented in FIG. 1;

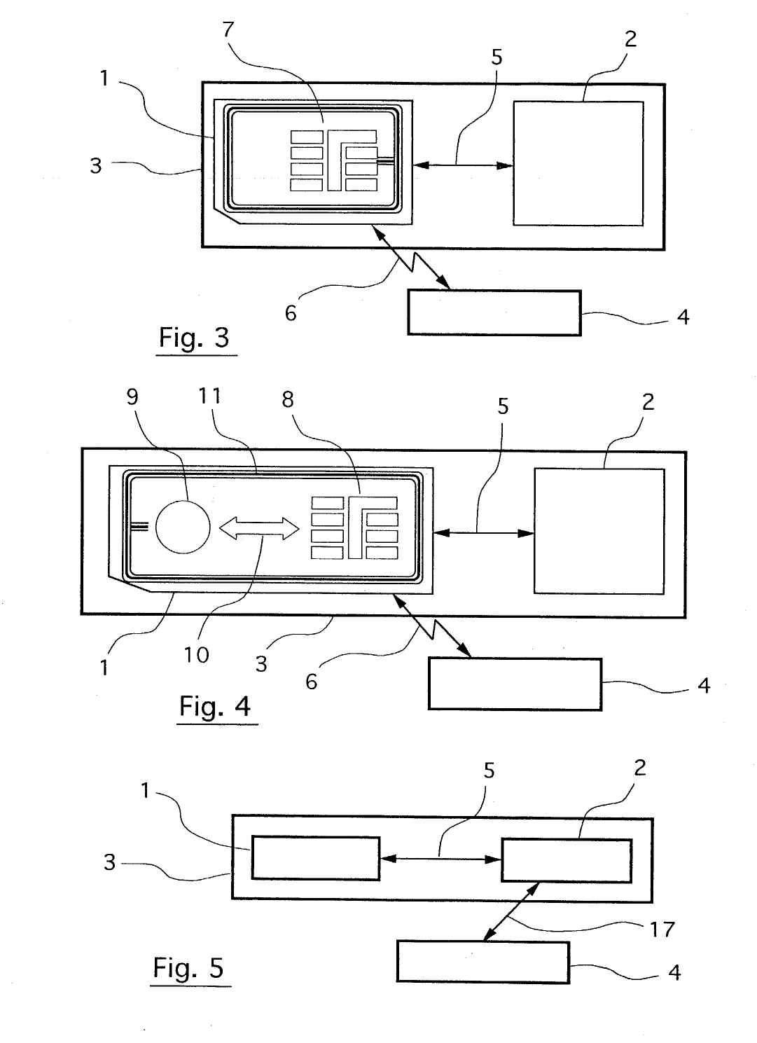

FIGS. 3 and 4 represent each a variant embodiment of the subscriber identification module in the context of the interactive structure represented in FIG. 1;

FIG. 5 represents a second particular embodiment of the method according to the invention of interactive exchange between a subscriber identification module and a local device;

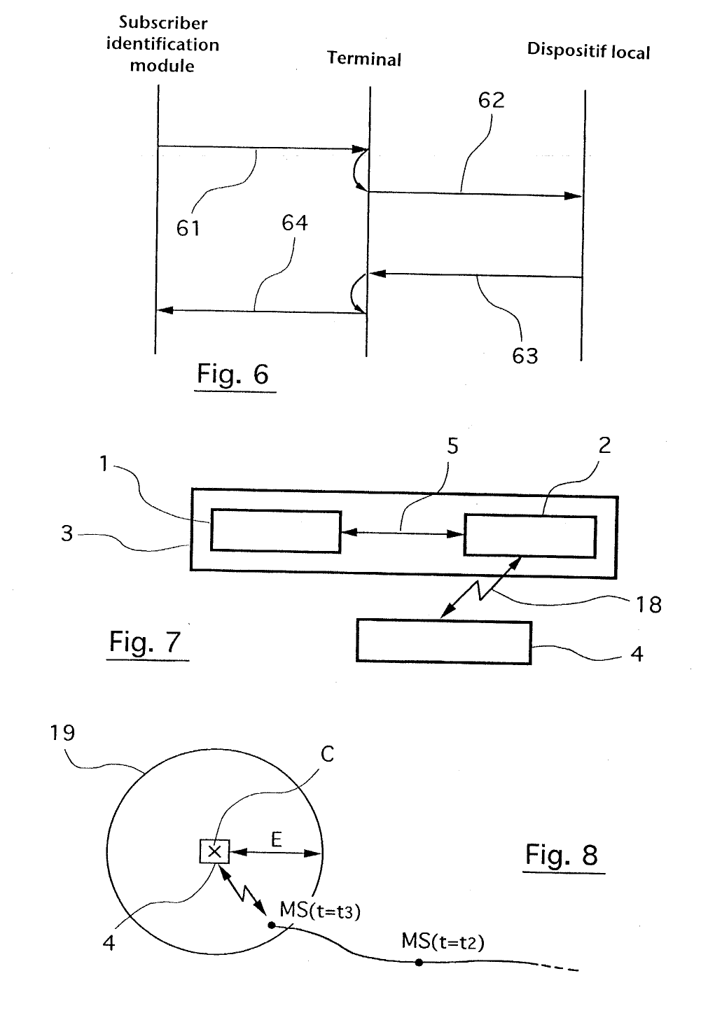

FIG. 6 represents a particular embodiment of a message exchange protocol in the context of the interactive structure represented in FIG. 5;

FIG. 7 represents a third particular embodiment of the method according to the invention of interactive exchanged between a subscriber identification module and a local device;

FIG. 8 represents a particular application for detecting the presence of the method according to the invention of interactive exchanged between a subscriber identification module and a local device.

It will be recalled that the general principle of the invention consists in establishing an interactive exchanged together with a subscriber identification module and a local device. In order to do this a communications channel is established between the two entities enabling movement of messages. These messages enable the subscriber identification module to receive and/or to request information from the local device and/or vice-versa.

Optionally, each message exchanged in a given direction over the aforementioned communications channel is associated with an acknowledgement of satisfactory reception in the reverse direction. This confirmation can possibly carry data.

In order to secure the exchanges, the messages carried over the aforementioned communications channel can be digitized in accordance with an encryption algorithm. Optionally, the latter will vary and depends on at least one parameter, itself a function of a local device and/or the subscriber identification module.

It is presumed that the subscriber identification module (or SIM card according to the GSM terminology) is of the type that co-operates with a terminal within a radiotelephone. Classically, the subscriber identification module is in physical contact with the terminal.

In the set of figures described hereinafter, the subscriber identification module is referenced using 1, the terminal using 2, the radiotelephone using 3 and the local device using 4. In addition, the physical contact between the subscriber identification module 1 and the terminal 2 is symbolized by an arrow referenced using 5.

A first particular embodiment of the method according to the invention or interactive exchanged between the subscriber identification module 1 and the local device 4 will be described relative to FIG. 1.

In this first embodiment, the aforementioned communications channel is implemented by a non-physical contact, a so-called quasi-contact (symbolized by an arrow 6), between the subscriber identification module 1 and the local device 4.

The notion of “quasi-contact” between the subscriber identification module and the local device covers all types of proximity connection, without physical contact. It is preferably a short-distance quasi-contact (0.1 cm to 2 m, approximately) and/or medium distance (0.1 cm to 50 m, approximately) by electromagnetic waves of any nature (including optical), or even a short-distance quasi-contact (0.5 cm to 2 m) and/or medium-distance (0.1 to 50 m, approximately) by sound or ultrasound waves. Several preferred methods of implementing this quasi-contact are described in detail hereinafter in the description.

In one variant embodiment, the communications channel by quasi-contact is bi-directional at short-distance (0.1 cm to 2 m, approximately) and unidirectional from the local device 4 to the subscriber identification module 1, at medium distance (from 2 m to 50 m, approximately).

At this point, a series of different options of the method of realization of the quasi-contact between the subscriber identification module and the local device will be presented.

According to a first method option, the quasi-contact is realized according to the method of “contactless” procedures based on an adaptation (namely in the format and conditions of the micro-SIM, for example) of the ISO 14443 and 15693 standards. This enables a short-distance quasi-contact (0.1 cm to 2 m, approximately) by electromagnetic waves.

According to a second option of the method, the quasi-contact is realized according to the method of the active and/or passive tag-based procedure (“tags”). This enables a short-distance quasi-contact (0.1 cm to 2 m, approximately) and/or medium distance (0.1 cm to 50 m, approximately) by electromagnetic waves.

According to a third option of the method, the quasi-contact is realized according the method of infrared communications (IrDa). This enables a medium-distance quasi-contact (0.1 cm to 50 m, approximately) by electromagnetic waves.

According to a fourth option of the method, the quasi-contact is realized according to the method of electromagnetic connection in the 400 MHz or 900 MHz band. This enables a medium-distance quasi-contact by electromagnetic waves.

According to a fifth option of the method, the quasi-contact is realized according to the local wireless network communications method (conformant with the ETSI 300 328 and 300 826 specifications). This enables a medium-distance quasi-contact (0.1 cm to 50 m, approximately) by electromagnetic waves.

According to a sixth option of the method, the local device has a simplified function of a base station emulation of a mobile radio communications network. The local device is associated with a geographical pseudo-cell having an identifier. The quasi-contact between the subscriber identification module and the local device is realized when the radiotelephone recognizes the identifier of the geographical pseudo-cell. This recognition is based, for example, on the standard mechanisms of the SIM ToolKit. In other respects, the identifier of the geographical pseudo-cell can be transmitted encoded (encrypted) by the pseudo-station of the base that emulates the local device. It is then decrypted (decoded) by the subscriber identification module. Optionally, the encryption/decryption algorithm used varies and depends on at least one parameter which is itself a function of the geographical pseudo-cell and/or known subscriber parameters of the subscriber identification module.

Two variants of the embodiment of the subscriber identification module 1 will be described with reference to FIGS. 3 and 4 in the context of the interactive exchange illustrated in FIG. 1 (first embodiment of the invention).

In the first variant (see FIG. 3), the subscriber identification module 1 comprises a single member 7. “Member” is understood to mean any unit of calculation and/or memorization, analog or digital, and integrated or associated with to the subscriber identification module.

This single member 7 includes, classically, an interactive interface with the terminal 2 via the physical contact 5 between it and the subscriber identification module. According to the invention it comprises in addition means (including a coil antenna 11) for establishing the quasi-contact 6, constituting a transmission/reception interface of the subscriber identification module to/from the local device. The local device itself also comprises means for establishing the quasi-contact 6, constituting a transmission/reception interface from the local device to/form the subscriber identification module. For instance, frequencies from 13.56 MHz or 433 MHz (or another) are used over the transmission/reception interfaces.

The single member 7 represents, simultaneously or alternately, a first functional mode as subscriber identification module and a second functional mode as means of establishing the quasi-contact. Classically, in the first functional mode, specific to the present invention, either the member 7 is supplied by the terminal or it draws its power from a signal produced by the local device. In other respects, in order to establish a communications channel between them, the two functional modes share at least one common memory.

In a second variant (see FIG. 4), the subscriber identification module 1 comprises:

classically a first member 8 establishing the contact 5 with the terminal 2;

in a manner specific to the invention, a second member 9, establishing the quasi-contact 6 with the local device 4. For this purpose the second member 9 comprises a coil antenna 11.

The two members 8 and 9 can be simultaneously or alternately activated and interact together. They are included in a common support or arrange on different supports. They are connected by a communications channel 10 (a connection integrated in the body of the subscriber identification module, wired, layered, etc.).

Classically, the first member 8 is supplied by the terminal. The second member 9 is supplied by the terminal or it may even draw its power from a signal produced by the local device (and more precisely from a signal emitted by a fixed contactless coupler arranged in the local device). The range of the quasi-contact is greater in the case of supply by the terminal.

Different variants of the embodiment of exchange of messages between two applications in the context of the interactive exchange represented in FIG. 1 will now be described with reference to FIG. 2.

In a general fashion, the communications channel between the subscriber identification module 1 and the local device 4 establishes a unilateral or bilateral exchange of messages between:

a first application arranged on or upstream of the subscriber identification module;

a second application arranged on or downstream of the local device.

The upstream of the subscriber identification module 1 is defined as either the terminal 2 or a radio communications network 12 to which the terminal 2 accesses or a system 13 connected to the radio communications network 12. Thus, in FIG. 2, the first application is referenced using A1, A2, A3 or A4 according to whether it is arranged on the subscriber identification module 1, on the terminal 2, on the radio communications network 12 or on the system 13.

The downstream of the local device 4 is defined as either an item of equipment 14 connected directly to the local device 4 or an item of equipment 15 connected indirectly to the local device 4 (via a communications or radio communications network 16, for example). Thus, in FIG. 2, the second application is reverenced using B1, B2 or B3 depending on whether it is arranged on the local device 4, on the item of equipment 14 or the item of equipment 15.

In a particular embodiment, the messages exchanged between the two applications are asynchronous and triggered by one or the other of the applications.

The aforesaid mechanism described relative to FIG. 2, for exchanging messages between two applications the one arranged on or upstream of the subscriber identification module and the other arranged on or downstream of the local device can likewise be applied to any embodiment of the invention and consequently to the second and third embodiments discussed hereinbefore (in relation to FIGS. 5 and 7, respectively).

A second particular embodiment of the method according to the invention for interactive exchange between the subscriber identification module 1 and the local device 4 will now be described with reference to FIG. 5.

In a second embodiment, the communications channel between the subscriber identification module 1 and the local device 4 is established by:

a first physical contact (symbolized by an arrow 5) between the subscriber identification module 1 and the terminal 2, and

a second physical contact (symbolized by an arrow 17) between the terminal 2 and the local device 4.

The upper part of FIG. 6 represents a particular embodiment of the mechanism for sending a message from the subscriber identification module 1 to the local device 4. The mechanism functions as follows:

the subscriber identification module 1 sends a first command 61 for transfer of data (“send to device”) to the terminal 2 via the first physical contact 5;

on receipt of the first aforesaid command 61 the terminal 2 generates a second command 62 for data transfer (“send2 to device”) to the local device 4 via the second physical contact 17.

The first command 61 comprises, for instance, on the one hand a query containing the identifier enabling it to be recognized by the terminal and on the other hand a body capable of containing useful data, for example. The structure of the second command can be identical to that of the first command. If the body of the first command 61 carries useful data, the terminal 2 copies them to the body of the second command 62. In this case, the data together with their semantics, carried by the second command 62 are identical to those of the first command 61.

The lower part of FIG. 6 represents a particular embodiment of the mechanism of sending a message from the local device 4 to the subscriber identification module 1. This mechanism functions as follows:

the local device 4 sends a third command 63 for data transfer (“send1 to SIM”) to the terminal 2 via the second physical contact 17;

on receiving the third aforesaid command 63 the terminal 2 generates a fourth command 64 for data transfer (“send2 to SIM”) to the subscriber identification module 1 via the first physical contact 5.

The data together with their semanticscarried by the fourth command 64 are identical to those of the third command 63.

The four aforesaid commands 61 t 64 are preferably added to at least one of the following GSM standards or to all iterations thereof:

GSM 11.14 SIM Application ToolKit

GSM 11.11 SIM-ME Interface

GSM 07.07 AT command set for GSM Mobile Equipment

etc.

A third particular embodiment of the method according to the invention for interactive exchange between the subscriber identification module 1 and the local device 4 will be described with reference to FIG. 7.

In a third embodiment, the communications channel between the subscriber identification module 1 and the local device 4 is established by:

a first physical contact (symbolized by an arrow 5) between the subscriber identification module 1 and the terminal 2, and

a second non-physical contact (symbolized by an arrow 18) between the terminal 2 and the local device 4.

The establishment of quasi-contact 18 between the terminal 2 and the local device 4 is, for example, realized according to the Bluetooth (or any development or variant of it) specification. In this case the terminal 2 and the local device 4 each have a distinct Bluetooth address.

For more details on the Bluetooth specification, reference can be made to the version 1.0B of the specification “Core and profile” of Dec. 1, 1999. It is recalled that the Bluetooth method aims at enabling all types of domestic radio exchanges by virtue of an information exchanged between to members included in two devices called “Bluetooth devices.” Each of the two members is capable of transmitting and receiving data by ultra-high frequency radio wave at a radius of 10 meters or more. In order to be able to use this technique in the context of the present invention it is proposed that the standard and the Bluetooth profiles be enhanced in the course of their development.

The mechanism of sending a message from the subscriber identification module 1 to the local device 4, for example, has operates as follows:

the subscriber identification module 1 sends a command for data transfer (“send BT”) to the terminal 2 via the first physical contact 5. This command comprises an address field (header) containing the Bluetooth address of the local device 4 and a data field (body) containing the data;

on receipt of the aforesaid command, the terminal 2 sends to the local device 4, in accordance with the Bluetooth specification, the data contained in the data field of the command.

As for the commands in the second embodiment of the invention, the command is preferably added to at least one of the aforesaid GSM standards and to any iterations of same.

The method of sending a message from the local device 4 to the subscriber identification module 1, for example operates as follows:

the address or a sub-address of a Bluetooth entity (the terminal, for example) is associated with the subscriber identification module 1;

the local device 4 sends a data transfer command (“send SIM”) to the terminal 2 in accordance with the Bluetooth specification. This command comprises an address field carrying the Bluetooth address of the terminal and a sub-address field or address field of the subscriber identification module;

on receiving the aforesaid command, the terminal 2 sends to the subscriber identification module 1 the data contained in the data field of the command.

An application of the method according to the invention for detecting the presence of the subscriber identification module 1 (and thus of the radiotelephone 3) inside a predetermined fixed location 19 will now be described with reference to FIG. 8. The local device 4 is called a “presence detection device” in this case.

The geographic position C and the range E from the predetermined fixed location 19 are defined, respectively, by the geographic position of the local device 4 and the radius of the quasi-contact between the local device 4 and the subscriber identification module 1.

The predetermined fixed location 19 is narrowly spatially delimited. It is, for example, constituted by a space of approximately 50 m and preferably of less than 20 m (even several centimeters). It is, for example, a precise geographic position of a lace of domestic habitation, a workplace, a location of temporary presence, a secondary residence, a retail shop, etc. In the example represented in FIG. 8, it is presumed that at the moment t, the radiotelephone (reference MS) passes to the interior of the predetermined fixed location 19.

It is considered that the radiotelephone 3 is present in the interior of the predetermined fixed location 19 if establishment of quasi-contact of the subscriber identification module 1 with the local device 4 is detected.

This enables, for example, management of a radiotelephone that can assume at least the following two functional states, each defined by at least one distinct status parameter:

a “mobile radiotelephone” state associated with a geographic mobility situation of the radiotelephone within a grid of geographic cells;

a “fixed radiotelephone” state associates with a stationery geographic situation of the radiotelephone within a predetermined fixed location that is narrowly spatially delimited.

The function of the radiotelephone in the “fixed radiotelephone” state can thus be conditioned by its establishment of quasi-contact with the local device 4.

It is clear that the local device 4 can easily be adapted to numerous other applications without departing from the context of the invention. The following different types of local devices can be conceived (this list is not exhaustive):

local interface devices enabling the exchange of information between two applications the one being arranged on or upstream of the subscriber identification module and the other one being arranged on or downstream of the local device;

the local presence detection devices;

the local access protection devices;

the local authentication and/or identification devices;

the local electronic payment devices;

the local devices for loading information into a list or otherwise, from the terminal and/or form the subscriber identification module;

the local devices for downloading data files or applications;

the local devices for loading data or applications from local computer equipment to the subscriber identification module and/or the terminal and/or a system upstream of the terminal/subscriber identification module pair;

etc.

Numerous other embodiments of the invention can also be conceived. It can obviously be envisaged that a plurality of subscriber identification module interacts, simultaneously or not, with the same local device. It can also be envisaged that a same subscriber identification module interacts, simultaneously or not, with several local devices.

1. A method of interactive exchange between a subscriber identification module co-operating with a terminal within a radiotelephone and at least one local device,
characterized in that it comprises a phase of establishing a first communications channel between the local device and the subscriber identification module, and in that the first communications channel carries at least one message enabling the subscriber identification module to receive and/or request information from the local device and/or vice-versa.

2. A method according to claim 1, wherein the first communications channel-effects a unilateral or a bilateral exchange of messages between two applications one of which is arranged on or upstream of the subscriber identification module and the other on or downstream of the local device,
wherein the upstream of the subscriber identification module is defined as either the terminal or a radio communications network accessed by the terminal or a system connected to the radio communications network,
and wherein the downstream of the local device is defined as any equipment connected directly or indirectly to the local device.

3. A method according to any one of claims 1 and 2, wherein the local device belongs to the group comprising:
local interface devices enabling the exchange of information between two applications the one of which is arranged on or upstream of the subscriber identification module and the other on or downstream of the local device;
local presence detection devices;
local access protection devices;
local authentication and/or identification devices;
local electronic payment devices;
local devices for loading information into a list, or otherwise, from the terminal and/or from the subscriber identification module;
local devices for downloading data files or applications;
local devices for loading data or applications from local computer equipment to the subscriber identification module and/or the terminal and/or a system upstream of the terminal/subscriber identification module pair.

4. A method according to any one of claims 1 to 3, wherein the first communications channel is used for detecting the presence of the radiotelephone on the inside of a-predetermined fixed location, wherein:
the geographic position is defined by the geographic position of the local device;
the range is defined by the radius of a contact or a quasi-contact between the local device and the radiotelephone by means of which the first communications channel is effected.

5. A method according to any one of claims 1 to 4, wherein each message exchanged in a given direction on the first communications channel is associated with an acknowledgement of satisfactory reception in the reverse direction, said confirmation being capable of carrying data.

6. A method according to any one of claims 1 to. 5, wherein the first communications channel effects an exchange of asynchronous messages between two applications one of which is arranged on or upstream of the subscriber identification module and the other is arranged on or downstream of the local device, the asynchronous messages being launched by one or the other of the two applications.

7. A method according to any one of claims 1 to 6, wherein the messages carried on the first communications channel are encoded according to an encoding algorithm.

8. A method according to claim 7, wherein the encoding algorithm varies and depends on at least one parameter, itself a function of the local device and/or the subscriber identification module.

9. A method according to any one of claims 1 to 8, wherein the first communications channel is effected by a non-physical contact, called a quasi-contact, between the subscriber identification module and said at least one local device.

10. A method according to claim 9, said subscriber identification module comprising in classical fashion a first member, wherein the subscriber, identification module comprises in addition a second member effecting the quasi-contact with the local device, wherein the first and second members can be simultaneously or alternately active and interact together and, wherein the first and second members are included in a common support or included on different supports but connected by a second communications channel.

11. A method according to claim 10, wherein the first and second members are supplied by the terminal.

12. A method according to claim 10, wherein the second member draws its power from a signal produced by a local device.

13. A method according to claim 9, the subscriber identification module comprising in classical fashion a member, wherein said member effects the quasi-contact.

14. A method according to claim 13, wherein the member simultaneously or alternately presents a first mode of function as the subscriber identification module and a second mode of function as means of effecting quasi-contact.

15. A method according to claim 14, wherein in the first and second modes of function, the member is supplied by the terminal.

16. A method according to claim 14, wherein in the first mode of function, the means is supplied by the terminal and, wherein in the second mode of function the member draws its energy from a signal produced by the local device.

17. A method according to any one of claims 14 to 16, wherein the first and second mode of function share at least one common memory, establishing a second communications channel between the first and second modes of function.

18. A method according to any one of claims 9 to 17, wherein the first communications channel by quasi-contact is short-distance bi-directional, from 0.1 cm to 2 m approximately, and unidirectional, from the local device to the subscriber identification module at medium-distance, from 2 m to 50 m, approximately.

19. A method according to any one of claims 9 to 18, wherein the quasi-contact belongs to the group comprising:
short-distance quasi-contacts from approximately 1 cm to 2 m and medium-distance from approximately 0.1 cm to 50 m by electromagnetic waves of any nature short-distance quasi-contacts from approximately 0.1 cm to 2 m and medium-distance from approximately 0.1 cm to 50 m by sound or ultrasound waves.

20. A method according to any one of claims 9 to 18, wherein the establishment of quasi-contact is realized according to the methods of “contactless” technology based on an adaptation of the ISO 14443 and 15693 standards, enabling a short-distance quasi-contact by electromagnetic waves.

21. A method according to any one of claims 9 to 18, wherein the establishment of quasi-contact is realized according to the methods of active and/or passive tags technology enabling short-distance and/or medium-distance quasi-contact by electromagnetic waves.

22. A method according to any one of claims 9 to 18, wherein establishment of quasi-contact is realized according to the methods of infrared communications, enabling a medium-distance quasi-contact by electromagnetic waves.

23. A method according to any one of claims 9 to 18, wherein the establishment of quasi-contact is realized according to the methods of communications by electromagnetic connections in the 400 MHz or 900 MHz band, enabling a medium-distance quasi-contact by electromagnetic waves.

24. A method according to any one, of claims 9 to 18, wherein the local device has a simplified function of emulation of base station of a mobile radio-communications network and is associated with a geographic pseudo-cell having an identifier,
and wherein the establishment of quasi-contact is realized when the radiotelephone, preferably the subscriber identification module, recognizes the identifier of the geographic pseudo-cell.

25. A method according to claim 24, wherein the identifier of the geographic pseudo-cell is emitted encrypted by the local device according to an encryption algorithm and then decrypted by the subscriber identification module.

26. A method according to claim 25, wherein the encryption algorithm varies and depends on at least one parameter, itself a function of the geographic pseudo-cell and/or parameters of the subscriber identification module.

27. A method according to any one of claims 9 to 18, wherein the establishment of quasi-contact is realized according the technology of communications over wireless local networks, enabling a medium-distance-quasi-contact by electromagnetic waves.

28. A method according to one of claims 1 to 8, wherein the first communications channel is effected by:
a first physical contact between the subscriber identification module and the terminal, and
a second physical contact between the terminal and said at least one local device.

29. A method according to claim 28, wherein in order to send a first message from the subscriber identification module to the local device utilization is made of:
a first data transfer command from the subscriber identification module to the terminal, the first command being added preferably to at least one of the following GSM standards: “GSM 11.14 SIM Application ToolKit”, “GSM 11.11 SIM-ME Interface”, “GSM 07.07 AT command set for GSM Mobile Equipment” or any developments of same.
a second data transfer command from the terminal to the local device, the second command being added preferably to at least one of the following GSM standards: “GSM 11.14 SIM Application ToolKit”, “GSM 11.11 SIM-ME Interface”, “GSM 07.07 AT command set for GSM Mobile Equipment” or any developments of same;
and wherein the second command is emitted by the terminal on receiving he first command.

30. A method according to claim 29, wherein the data together with their semantics carried by the second command are identical to those of the first command.

31. A method according to any one of claims 28 to 30, wherein in order to send a second message from the local device to the subscriber identification module, utilization is made of:
a third data transfer command from the local device to the terminal, the third command being added preferentially to at least one of the following GSM standards: “GSM 11.14 SIM Application ToolKit”, “GSM. 11.11 SIM-ME Interface”, “GSM 07.07 AT command set for GSM Mobile Equipment” or any developments of same;
a fourth data transfer command from the terminal to the subscriber identification module, the fourth command being added preferably to at least one of the following GSM standards: “GSM 11.14 SIM Application ToolKit”, “GSM 11.11 SIM-ME Interface”, “GSM 07.07 AT command set for GSM Mobile Equipment” or any developments of same;
and wherein the fourth command is emitted by the terminal on reception of the third command.

32. A method according to claim 31, wherein the data together with their semantics carried by the fourth command are identical to those of the third command.

33. A method according to one of claims 1 to 8, wherein the first communications channel is effected by:
a first physical contact between the subscriber identification module, and
a second non-physical contact, called a quasi-contact, between the terminal and said at least one local device.

34. A method according to claim 33, wherein the establishment of quasi-contact between the terminal and said at least one local device is realized according to the Bluetooth specification or any evolution or variant thereof, the terminal and said at least one local device each having one distinct Bluetooth address.

35. A method according to claim 34, wherein, in order to send a first message from the subscriber identification module to the local device, a data transfer command (“send BT”) is used from the subscriber identification module to the terminal, the command being preferably added to at least one of the following GSM standards: “GSM 11.14 SIM Application ToolKit”, “GSM 11.11 SIM-ME Interface”, “GSM 07.07 AT command set for GSM Mobile Equipment” or any developments of same,
wherein the command comprises an address field containing the Bluetooth address of the local device and a data field containing data,
wherein upon receiving the command the terminal sends to the local device, using the Bluetooth specification, the data contained in the data field.

36. A method according to any one of claims 34 and 35, wherein in order to send a second message from the local device to the subscriber identification module, a data transfer command is used (“send SIM”) from the local device to the terminal,
wherein the command comprises a terminal address field and a sub-address field or a subscriber identification module address field,
wherein, upon receiving the command, the terminal sends to the subscriber identification module those data contained in the data field of the command,
and wherein an address of a Bluetooth entity is attached to the subscriber identification module or a sub-address of a Bluetooth entity, preferably the terminal.

37. A radiotelephone of the type comprising a terminal and a subscriber identification module, characterized in that it comprises means of effecting a communications channel between the subscriber identification module and a local device, the communications channel carrying at least one message enabling the subscriber identification module to receive and/or to request information form the local device and/or vice-versa.

38. A subscriber identification module of the type intended to co-operate with a terminal within a radiotelephone, wherein said subscriber identification module comprises means of effecting a communications channel between the subscriber identification module and a local device, the communications channel carrying at least one message enabling the subscriber identification module to receive and/or request information from the local device and/or vice versa.

39. A local device of the type intended namely to communicate with a subscriber identification module, the subscriber identification module co-operating with a terminal within a radiotelephone, wherein said local device comprises means of effecting a communications channel between the local device and the subscriber identification module, the communications channel carrying at least one message enabling the subscriber identification module to receive and/or request information from the local device and/or vice versa.
